(19) United States
(12) Patent Application Publication
(10) Pub. No.: US 2015/0307656 A1
(43) Pub. Date: Oct. 29, 2015

(54) POLYMERIZATION METHOD

(71) Applicants: UNVERSITÉ DE STRASBOURG, STRASBOURG (FR); CENTRE NATIONAL DE LA RECHERCHE SCIENTIFIQUE - CNRS -, Paris Cedex 16 (FR)

(72) Inventors: Samuel DAGORNE, Strasbourg (FR); Frederic HILD, Wingen-Sur-Moder (FR)

(21) Appl. No.: 14/650,467

(22) PCT Filed: Dec. 9, 2013
(86) PCT No.: PCT/EP2013/075977

§ 371 Date: Jun. 8, 2015

(30) Foreign Application Priority Data
Dec. 7, 2012 (EP) 12364007.0
Dec. 13, 2012 (EP) 12290436.0

(51) Int. Cl. C08G 63/82; C08G 63/08

(52) U.S. Cl. CPC C08G 63/823; C08G 63/08

(57) ABSTRACT

A novel polymerisation method employing novel cationic Zinc-complexes as catalyst is devised.

### PRIORITY

This application claims priority to European Patent Application Nos EP 12364007.0 filed on 7 Dec. 2012, and EP 12290436.0 filed on 13 Dec. 2012. The entire contents of each of these applications are incorporated herein by reference.

### FIELD OF THE INVENTION

The present invention relates to a new method of ring-opening polymerisation (ROP) of cyclic lactones and carbonates, a new cationic initiator complex to be used in such method and a new polymer obtained by such method, which polymer preferably is a polylactide polymer.

### BACKGROUND OF THE INVENTION

Polyester polymers such as poly-ε-caprolactone or polylactide are hallmarks of a greener chemistry. They are biodegradable, and the cyclic monomers are obtained by processing of biological, renewable raw material. Hitherto, ring-opening polymerisation (ROP) suffered from use of organic solvents as well as from a comparatively low activity of the polymerisation catalysts, resulting in lower average chain length of the polymers thus obtained. Chain termination or transfer reactions such as back-biting or scrambling are inter alia affected by the monomer concentration, the type of catalyst used and impurities in the monomer preparation. Nonetheless, ROP as a living polymerization theoretically allows of obtaining particularly well defined polymers having a very low polydispersity and thus very uniform product properties. The latter is particularly important for pharmaceutical appliances requiring regulatory approval.

Wheaton et al. (Chem. Commun. 2010, 46, 8404-8406) [1] describes a novel cationic zinc-lactatester complex decorated with a tridentate bisphosphinimine ligand that, compared to the corresponding cationic alkyl-zinc complexes, showed good activity in the polymerisation of rac-lactide. However, the author also observed problems in obtaining higher molecular weights, high catalyst loads decreasing the number average molecular weight Mn of the polymer. High monomer loadings in contrast proved to shift the product Mn not in a linear, but asymptotic fashion to higher molecular weight, at the price of a strong increase in polydispersity by increasing level of side and chain termination reactions. Similarly, the present inventors earlier described in Romain et al. (Chem. Commun. 2012, 48, 22 13-2215) [2] an uncharged, tridentate N-heterocyclic carbene ligand complex with Zircone which proved to polymerize rac-lactide in stereoselective manner. Whilst molecular weight Mn was found to increase in a more linear fashion with monomer concentration, polydispersity of the polymer product displayed a sharp broadening even at chain lengths of <10.000 g/mol. Ovitt et al. (J. Polymer Sc. 2000, Part A: Polymer Chemistry, Vol. 38, 4686-4692) [3] reported obtaining polylactide from rac-lactide having alternating stereoblockwise isotacticity by polymerising rac-lactide with a racemic, uncharged aluminium-alkoxide catalyst. The catalyst employed an atropisomeric, tetradentate Binap-type ligand; chain shuttling between different enantiomers of the catalyst species was held to account for the stereoblock tacticity and hence kinetic resolution of the racemic monomer mixture. However, polymerisation was thus not conducted in a living mode, and correspondingly rather low average chain lengths were obtained only.

It is an object of the invention to overcome the disadvantages known in the art and to devise a more efficient catalyst for ROP allowing of obtaining higher molecular weights concomitant with preserving a narrow polydispersity index.

### BRIEF DESCRIPTION OF THE DRAWING

FIG. 1A shows a table compiling representative results in the ROP of lactide mediated by a Zn cation/BnOH catalyst according to Example 4. ^{a} Conditions: 130° C., bulk (no solvent), M=monomer (S-LA, rac-LA=rac-lactide), Init=(Et₂O)₃Zn—OBn⁺ (anion=B(C₆F₅)₄). ^{b} 90° C., solvent=toluene. ^{c} determined by ¹H NMR. ^{d} determined by GPC.^{e}

FIG. 1B shows a table compiling representative results in the ROP of lactide mediated by a Zn cation/BnOH catalyst according to Example 5. ^{a} Conditions: bulk (no solvent), M=monomer, Init=(Et₂O)₃Zn—OBn⁺ (anion=B(C₆F₅)₄). ^{b} 90° C., solvent=toluene. ^{c} determined by ¹H NMR. ^{d} determined by GPC.^{e} vigorous and regular stirring of the reaction medium was applied and maintained during the ROP catalysis.

FIG. 2 depicts Mₙ of the produced PLA as a function of lactide conversion. Conditions: monomer/alcohol/catalyst (1500/5/1), bulk conditions, 120° C., 1 h.

FIG. 3 depicts an ¹H NMR spectrum of isotactic PLLA (from L-LA) produced according to the method of the invention.

FIG. 4 depicts a Gel Permeation Chromatography (GPC) spectrum of isotactic PLLA (from L-LA) produced according to the method of the invention.

FIG. 5 depicts a differential scanning calorimetry (DSC) spectrum of isotactic PLLA (from L-LA) produced according to the method of the invention.

### DEFINITIONS

To facilitate an understanding of the present invention, a number of terms and phrases are defined below:

In general, the term “substituted” whether preceded by the term “optionally” or not, and substituents contained in formulae of this invention, refer to the replacement of hydrogen radicals in a given structure with the radical of a specified substituent. When more than one position in any given structure may be substituted with more than one substituent selected from a specified group, the substituent may be either the same or different at every position. As used herein, the term “substituted” is contemplated to include all permissible substituents of organic compounds.

As used herein, the term “alkyl”, as used herein, straight and branched alkyl groups. An analogous convention applies to other generic terms such as “alkenyl”, “alkynyl” and the like. In certain embodiments, as used herein, “lower alkyl” is used to indicate those alkyl groups (substituted, unsubstituted, branched or unbranched) having about 1-6 carbon atoms. Illustrative alkyl groups include, but are not limited to, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, sec-hexyl, moieties and the like, which again, may bear one or more substituents.

Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl and the like.

In general, the term “aromatic moiety” or “aryl”, as used herein, refers to stable substituted or unsubstituted unsaturated mono- or polycyclic hydrocarbon moieties having preferably 3-14 carbon atoms, comprising at least one ring satisfying the Huckel rule for aromaticity. Examples of aromatic moieties include, but are not limited to, phenyl, indanyl, indenyl, naphthyl, phenanthryl and anthracyl. As used herein, the term “alkylaryl” refers to an aryl moiety bearing at least one alkyl substituent, the alkylaryl moiety being bound to the rest of the molecule via any of the aryl ring atoms not already bearing a substituent. As an example, the term “C6-C14 alkylaryl” refers to an alkyl aryl moiety, as defined above, which contains a total of 6 to 14 carbon atoms between the alkyl and aryl groups. For example, a methylphenyl moiety is a C7alkylaryl. For example, “C6-C14 alkylaryl” encompasses C0-C4alkylC6-C10aryl moieties.

Similarly, the term “aralkyl” refers to an alkyl moiety bearing at least one aryl substituent, the aralkyl moiety being bound to the rest of the molecule via any of the alkyl chain atoms not already bearing a substituent. As an example, the term “C6-C14 aralkyl” refers to an aralkyl moiety, as defined above, which contains a total of 6 to 14 carbon atoms between the alkyl and aryl groups. For example, a phenylethyl moiety, which contains a total of 8 carbon atoms, is a C8aralkyl. For example, “C6-C14 aralkyl” encompasses C6-C10arylC0-C4alkyl moieties. In general, the term “heteroaromatic moiety”, “heteroaryl” or “heteroaryl”, as used herein, refers to stable substituted or unsubstituted aromatic moieties, as defined above, having from about five to about ten ring atoms of which one ring atom is selected from S, O and N; zero, one or two ring atoms are additional heteroatoms independently selected from S, O and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like.

As used herein, the term “silyl” refers to a —Si(R)₃ or —Si(R₂)— moiety wherein each occurrence of R is independently a C1-C6alkyl or C6-C10aryl moiety. The term “halogeno” as used herein refers to an atom selected from fluorine, chlorine, bromine and iodine.

As used herein, the term “ether” refers to a moiety having the structure -C1-6alkyl-O—R wherein R represents a C1-6alkyl moiety.

As used herein, the term “amido” refers to a moiety having the structure —NR—C(═O)— or —C(═O)NR— wherein R represents H or a C1-6alkyl moiety.

As used herein, the term “amidino” refers to a moiety having the structure —C═N(R)—NR₂ wherein each occurrence of R independently represents H or a C1-6alkyl moiety.

As used herein, the term “oxirane” refers to a moiety having the structure:

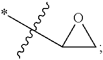

wherein “*” denotes the point of attachment of the oxirane moiety to the rest of the molecule.

As used herein, the terms “independently” and ‘individually” are used interchangeably to signify that the substituents, atoms or moieties to which these terms refer, are selected from the list of variables independently from each other (i.e., they may be identical or the same).

As used herein, the expression “C, —C_{y}, preferably Cₓ₁-C_{y1}, alkylaryl, aralkyl or aryl”, where x, y, x1 and y1 represent integers denoting the number of carbon atoms in the chemical moiety to which it refers (e.g., “alkylaryl”, “aralkyl”, “aryl”)), means “Cₓ-C_{y}alkylaryl, Cₓ-C_{y}aralkyl or Cₓ-C_{y}aryl, preferably Cₓ₁-C_{y1}alkylaryl, Cₓ₁-C_{y1} aralkyl or Cₓ₁-C_{y1}aryl”. Likewise, the expression “Cₓ-C_{y} alkylaryl, aralkyl or aryl”, means “Cₓ-C_{y}alkylaryl, Cₓ-C_{y}aralkyl or Cₓ-C_{y}aryl”. As used herein, the term “rac-lactide”, whether the suffix “rac” may be in italics or not, refers to racemic-lactide.

### DETAILED DESCRIPTION OF CERTAIN PREFERRED EMBODIMENTS OF THE INVENTION

As noted above, there has been increasing interest in recent years in the development more efficient catalysts for ROP.

In this context, there is provided herein a novel polymerisation protocol for ROP of polyesters or polycarbonats, further employing a novel catalyst species. According to the present invention, in one aspect, there is provided a polymerisation method, preferably for the obtention of a polyester or a polycarbonate or a co- or blockpolymeric mixed polymer thereof, comprising the step of polymerising at least one type of monomer selected from the group consisting of a monomer of formula I

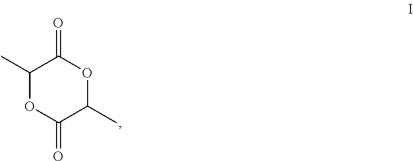

a monomer of formula II

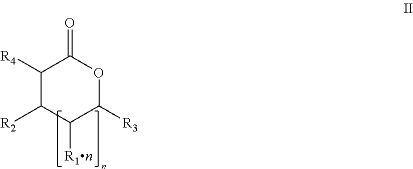

and a monomer of formula III

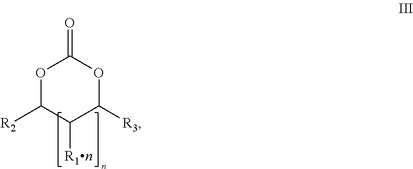

wherein independently in each of formulae I, II, III, n=0, 1 or 2. It is particularly preferred that in formula II n is preferably 1 or 2, more preferably is 1, and/or that in formula III, n is preferably 1.

Advantageously, R1.n, R2, R3 and R4, independently, represent H, C1-C25 linear, branched or cyclic alkyl, C5-C25, preferably C6-C14, alkylaryl, aralkyl or aryl, wherein the alkyl and/or the aryl moieties may be, individually, further substituted with halogeno, preferably Cl or F, or wherein the alkyl may comprise an oxirane, ether, amido, amidino, alkenyl or alkinyl moiety.

Advantageously, the polymerisation according to the method of the present invention may be carried out in the presence of a cationic initiator complex of formula IV

(Lₘ M-R^{a})⁺ IV

or of formula V

(Lₘ M-O—R^{a})⁺ V

wherein
L represents a neutral, monodentate ligand, wherein m=1, 2, 3 or 4,
M represents a zinc, magnesium or calcium atom, preferably a zinc atom, having an oxidation state of +II. According to conventions in inorganic chemistry and in accordance with the present invention, the letter ′L′ designates an organic, ancillary ligand binding coordinatively to the central metal atom M via its free electron pair. For example, the electron pair may be that of a N or O atom. Advantageously, M is Zn and m is 3.
R^{a} represents an organic radical which is linear, branched or cyclic, preferably linear, C1-20alkyl, preferably C1-C10alkyl, or Si1-Si10silyl, C6-C14 alkylaryl, aralkyl or aryl, and wherein the alkyl or aryl moieties may be, individually, further substituted with halogeno, preferably F or Cl, and wherein the aryl moieties may comprise N- and/or O-heteroaromatic aryl (i.e. an N- or O-containing heteroaryl moiety), and wherein the alkyl, silyl or aryl moieties may be, individually, further substituted with —NR^{b}R^{c}, —COO—R^{b}, —O—C(═O)—R^{b}, —NH—C(═O)—R^{b}, —C(═O)NH—R^{b}, —OH, —NHC(═O)NHR^{b}, —OBoc, —NHBoc, (—(O)ᵥSi[—(O)ₓR^{b}][—(O)_{y}R^{x}][—(O)_{z}R^{d}])₁ with the proviso that v, x, y, z are, individually, 0 or 1, and that 1 is 1, 2, 3, 4 or 5; or wherein, when the complex is of formula V, the alkyl, silyl or aryl moieties may be, individually, further substituted with —O—R^{b}, —S—R^{b} or —PR^{b}R^{c},
wherein R^{b}, R^{c}, R^{d}, individually, are C1-C14 alkyl or C6-C14 aryl, arylalykl or aralkyl, which alkyl or aryl moieties may be further substituted with halogeno, preferably Cl or F.

Advantageously, R^{a} represents a linear C1-C10 alkyl, preferably methyl or ethyl.

Advantageously, R^{a} represents a branched C1-C10alkyl, wherein the alkyl may be further substituted with halogeno, preferably F or Cl, or —COO—R^{b}; wherein R^{b} represents C1-C14 alkyl, preferably C1-C6 alkyl.

Advantageously, the cationic initiator complex has formula V, R^{a} represents a branched C1-C10 alkyl, wherein the alkyl may be further substituted with halogeno, preferably F or Cl, or —COO—R^{b}; wherein R^{b} represents C1-C14 alkyl, and the initiator complex has the following structure:

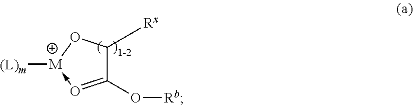

wherein m, L and Rb are as defined above, and each occurrence of R^{X} independently represents H or C1-6alkyl. Advantageously, the initiator complex has the following structure:

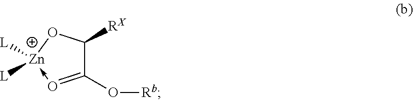

wherein L is OEt₂ or THF, and R^{b} and R^{X} are independently methyl or ethyl.

Advantageously, when the initiator complex is in the dative forms (a) and (b) above, the initiator may be more stable, for example to exposure to ambient air.

Advantageously, the initiator complex may be provided as a salt with X⁻, wherein X is as defined below, in all its variants and embodiments.

Fundamentally, the polymerisation method may be carried out with either one of the two catalyst species IV or V. However, when the polymerisation reaction is carried out with a cationic initiator complex of formula IV, then either the reaction is carried out in the further presence of an alcohol of formula VI

R^{a}—OH, VI

or the initiator complex is preincubated with an alcohol of formula VI, or both. Initiator complexes of formula IV may be prepared according to the following general scheme 1:

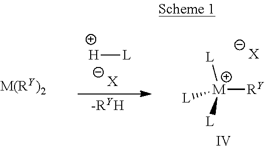

Initiator complexes of formula V may be prepared according to the following general scheme 2:

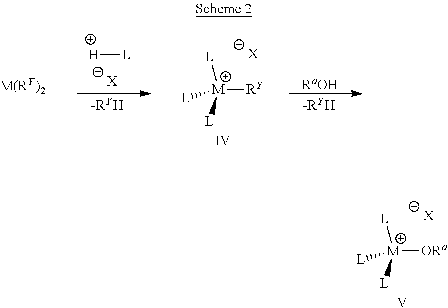

Initiator complexes of formula (a) may be prepared according to the following general scheme 3:

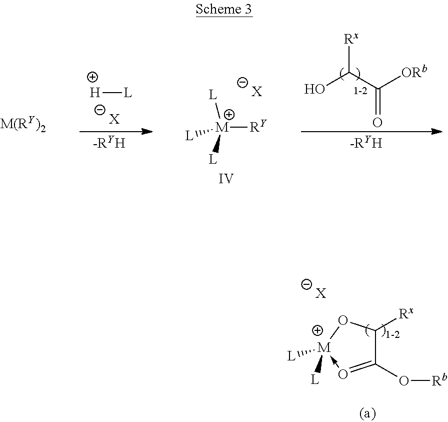

Preferably, the polymerisation may be carried out comprising at least a monomer of formula I, giving rise to a mixed or homogenous polylactide, and wherein said monomer of formula I is S-lactide (S,S-lactide) and/or is rac-lactide. S-lactide allows directly of obtaining stereopure, isotactic polymer product, having better crystallinity and thus higher melting point, suitable for extrusion processing and the like. More preferably, the polymerisation is carried out as to provide a block-copolymer product of the monomers of formula I and formula III.

In a further strongly preferred embodiment, the polymerisation may be carried out in the presence of the alcohol of formula VI, that is irrespective which catalyst complex IV or V is employed, and the polymerisation may be substantially carried out in the absence of any solvent other than the alcohol of formula VI and liquid monomer. Preferably, the polymerisation may be carried out at a temperature of from 110 to 145° C. Preferably the polymerisation may be carried out at a molar ratio of the initiator complex IV and/or V: alcohol VI: monomer of formula I, II and/or III of from 1: <3: <1000; most preferably said molar ratio may range from 1:≦4 to <10:≦1500. Advantageously, the inventive polymerisation method allows both best conversion rates as well as highest chain lengths, in terms of number average molecular weight, to be achieved, concomittant with a constantly narrow PDI. In addition, the excess of liquid monomer that can be used without detrimental effect on the polymerisation makes the use of any additional organic solvent obsolete, rendering the polymerisation method environmentally friendly. However, it is not only waste that is avoided, but also technical efforts for removing such solvent. This is particularly important in light of the fact that the presence of VOC in plastics presents a regulatory/toxicological problem in general, in particular for use in food packaging or medical implant applications, where biodegradability is sought after.

Without wanting to be bound by any particular theory, it is hypothesized that the unexpected high catalytic efficiency of the catalyst species of the present invention is achieved thanks to the use of monodentate, weakly binding ligands L; the binding of L is the result of using the neutral ligand L as a solvent during catalyst preparation. Advantageously, L is a monodentate Lewis base of the type O- or S-ether (linear or cyclic, for example diethyl ether, tetrahydrofurane, thiophene), amine (for example piperazine, aniline, 4-methyl- and 4-ethyl-aniline) or N-containing heteroaryl (for example, pyridine, pyrimidine, pyridazine), or mixed heteroaryl ligands such as oxazol, isooxazol, thiazol, isothiazol. L may be an apolar, preferably aprotic, solvent that is liquid at room temperature, and preferably boils at a temperature<100° C. (in other words, it can be easily removed by distillation under mild conditions in an evaporator), for example diethyl ether. L may also be a polar, preferably aprotic, solvent that is liquid at room temperature, and preferably boils at a temperature<100° C. (i.e., can be easily removed under mild conditions by means of a rotary evaporator), for example tetrahydrofuran (THF). Advantageously, L may be a ′soft′ Lewis base, according to the HSAB classification scheme of Pearson (R. Pearson, ′The HSAB principle—more quantitative aspects′, Inorganica Chimica Acta Vol. 240, No. 1/2, 1995, S.93-98). It is believed, without wanting to be bound by any particular theory, that once the catalyst according to the present invention is placed in the a more concentrated monomer liquid, these ancillary ligands L are replaced by monomer coordinating the cationic metal (e.g., zinc) via their ester groups (cf. initiator complex of formulae (a) and (b) above). As such, in contrast to the complex catalysts known in the art, in the polymerisation method of the present invention several molecules of the monomers are directly associated with the catalytic metal centre that is coordinating, presumably in a concerted manner, the reaction between the lactone or carbonate function of the monomer and the nascent, metal-coordinated alkoxy function of the growing chain end. This is quite a novel catalytic mechanism, compared to the tightly bound, large-structured multidentate ligands of the art. Additional experimental corroboration comes from the fact that, adding substantial (e.g. monomer: solvent=1:1) amounts of an inert solvent such as toluene to the reaction, completely killed catalyst activity, as is shown in the experimental section.

In another preferred embodiment, the polymerisation mixture may consist essentially of the alcohol of formula VI, the initator complex and at least one of the monomers I, II and/or III.

Advantageously preferred, the polymerisation may provide a polymer product having a number-average molecular weight (Mn)≧50.000 g/mol and a polydispersity index (PDI) value of from >1 to 1.6, preferably a PDI value of from 1.05 to 1.55, more preferably a PDI value of from 1.1 to 1.4. Advantageously, the polymerisation may provide a polymer product having a number-average molecular weight (Mn)≧50.000 g/mol and a polydispersity index (PDI) value ranging from 1.05 to 1.35.

The Mn value was routinely determined by GPC; GPC analyses were performed on a GPC system equipped with a Shimadzu RID10A refractometer detector and three 5-μl PL gel columns (300×7.5 mm, Varian Corporation and Mixed-C porosity) in series, and using HPLC-grade THF as an eluant. The GPC columns were eluted with THF at 45° C. at 1 mL/min and were calibrated with polystyrene standards, specifically 23 monodisperse polystyrene standards. Analysis of the GPC data and calculation of the Mn and PDI values was done with standard GPC software. Molecular weights and polydispersity indices (PDIs) were calculated using polystyrene standards. In the case of molecular weight number values (Mₙ), these were corrected using by multiplying the experimental values (PS standard) by the correcting factor 0.58 (cf: Save et al., Macromol. Chem. Phys. 2002, 203, 889-899) [14]. Accordingly, throughout this document, when Mn and DPI values are recited, they refer to measurements determined by GPC equipped with differential refractive index detectors, and polystyrene standard. Preferably, the measurements are done with THF as eluent, and at room temperature.

Alternatively, or additionally, the Mn and DPI values could be determined by GPC equipped with light diffraction detectors, and polystyrene standard.

Preferably, the ligand L is a polar or apolar; preferably aprotic, solvent that is liquid at 25° C. and comprises N, O and/or S as heteroatom, preferably is an aromatic N, S and/or O heterocycle with a ring size of 5 or 6 atoms, or is R^{q}—NH₂, R^{p}—O—R^{o}, R^{p}—S—R^{o} or R^{p}—CN, wherein R^{q} is C6 to C14 aryl or aralkyl and wherein R^{p}, R^{o} independently, are C1-C4 aliphatic, preferably linear, alkyl or are C6-C14 aryl or alkylaryl, preferably C6-C14 alkylaryl, more preferably L is selected from the group consisting of pyridine, pyrimidine, pyridazine, piperazine, aniline, 4-methyl- and 4-ethyl-aniline, tetrahydrofurane, thiophene, oxazol, isooxazol, thiazol, isothiazol and ethers of formulae R^{p}—O—R^{o} and/or R^{p}—S—R^{o} wherein R^{p}, R^{o}, independently or symmetrically, represent C1-C3, preferably linear, alkyl, for example diethyl ether. The term “symmetrically”, as used herein, refers to the case where R^{p} and R^{o} are identical.

More preferred in the context of the above described polymerisation method, in formulae IV, V, VI, R^{a} may be linear, cyclic or branched C1-C10 alkyl, or may be C6-C14 alkylaryl when the initiator complex is of formula V; and wherein the alkyl or aryl moieties may be, individually, further substituted with halogeno, preferably F or Cl. Advantageously, R^{a} may be methyl, ethyl, n-propyl ori-propyl, or may be benzyl when the initiator complex is of formula V.

Advantageously, the method according to the present invention may further comprise a step of washing the resulting polymer using a suitable solvent. Advantageously, the solvent is such that the polymer is insoluble in it, but the monomers or the initiator complex metallic salts are. Thus, the polymer precipitates out of solution upon addition of such a solvent. For example, the solvent may be methanol. In exemplary embodiments, the reaction mixture, after polymerisation, may be quenched in a suitable solvent, such as methanol, to precipitate the polymer. Prior to precipitation with the suitable solvent, the reaction mixture may first be cooled to room temperature. After precipitation, the polymer may then be isolated by filtering, with optional further washing(s) as needed, to yield a polymer product substantially free of residual monomer and initiator complex metallic salt.

A further object of the invention is a polymer which is a polyester or a polycarbonate or a mixed-polymer thereof which may be co- or blockpolymeric, said polymer comprising at least monomers of formulae I, II and/or III, the above given definitions for the monomers being incorporated hereto by reference, which polymer product has a number-average molecular weight (Mn)≧50.000 g/mol and a polydispersity index (PDI) value of from >1 to 1.6, preferably a PDI value of from 1.05 to 1.55, more preferably a PDI value of from 1.1 to 1.4. Advantageously, the polymerisation may provide a polymer product having a number-average molecular weight (Mn)≧50.000 g/mol and a polydispersity index (PDI) value ranging from 1.05 to 1.35.

A further object of the present invention is a polymer obtained by a polymerisation method according to the present invention, according to anyone or more of the various embodiments described herein, which is preferably a polyester or a polycarbonat or a mixed-polymer thereof which may be co- or blockpolymeric, wherein the polymer product has a number-average molecular weight (Mn)≧50.000 g/mol and a polydispersity index (PDI) value of from >1 to 1.6, preferably has a PDI value of from 1.05 to 1.55, more preferably a PDI value of from 1.1 to 1.4. Advantageously, the polymerisation may provide a polymer product having a number-average molecular weight (Mn)≧50.000 g/mol and a polydispersity index (PDI) value ranging from 1.05 to 1.35. Preferably, such polymer has been polymerised at least for part from the lactide monomer of formula I, preferably wherein the polymer is a block-copolymer product of the monomers of formula I and formula III and/or wherein the monomer of formula I was S,S-lactid for polymerising isotactic polymer segments with increased crystallinity therefrom. Adavntageously, due to the living polymerisation properties of the catalytic initiator complex of the present invention, a block-copolymer may be produced by polymerizing alternatingly the R- and the S-lactide monomer, to obtain a more stable polymer wherein inter- or intra-chain segments associate to form more stable, crystalline stereocomplexes of Poly(S-Lactide)/Poly (R-Lactide). This phenomenon and the associated, improved features of such product are known in the art.

Another object of the present invention is the cationic initiator complex for ring-opening polymerisation, according to the polymerisation method of the present invention in its above and below captioned embodiments or any combination thereof, said complex being of formula IV

(Lₘ M-R^{a})⁺ IV

or of formula V

(Lₘ M-O—R^{a})⁺ V

wherein
L represents a neutral, monodentate ligand, wherein m=1, 2, 3 or 4,
M represents a magnesium, calcium or zinc atom, preferably a zinc atom, having an oxidation state of +II,
R^{a} represents an organic radical which is linear, branched or cyclic, preferably linear, C1-20, preferably C1-C10, alkyl or Si1-Si10 silyl, C6-C14 alkylaryl, aralkyl or aryl, and wherein the alkyl or aryl moieties may be, individually, further substituted with halogeno, preferably F or Cl, and wherein the aryl moieties may comprise N- and/or O-heteroaromatic aryl, and wherein the alkyl, silyl or aryl moieties may be, individually, further substituted with —NR^{b}R^{c}, —COO—R^{b}, —O—C(═O)—R^{b}, —NH—C(═O)—R^{b}, —C(═O)NH—R^{b}, —OH, —NHC(═O)NHR^{b}, —OBoc, —NHBoc, (—(O)ᵥSi[—(O)ₓR^{b}][—(O)_{y}R^{c}][—(O)_{z}R^{d}])₁ with the proviso that v, x, y, z are, individually, 0 or 1, and that 1 is 1, 2, 3, 4 or 5, or wherein, when the complex is of formula V, the alkyl, silyl or aryl moieties may be, individually, further substituted with —O—R^{b}, —S—R^{b} or —PR^{b}R^{c},
and wherein R^{b}, R^{c}, R^{d}, individually, are C1-C14 alkyl or C6-C14 aryl, arylalykl or aralkyl, which alkyl or aryl moieties may be further substituted with halogeno, preferably Cl or F.

Preferably, the cationic initiator complex may be provided in the form of an ion pair or salt of formula VII

(Lₘ M-R^{a})⁺X⁻ VII

or of formula VIII

(Lₘ M-O—R^{a})⁺X⁻ VIII

wherein X⁻ is a lipophilic, sterically hindered complex anion, preferably is an anionic borate complex. Such lipophilic anions are well known from being used in phase transfer catalysis.

More preferably, X⁻ may be an anionic borate complex selected from the group consisting of tetrakis (pentafluoro-phenyl)-borate, C1-C4-alkyl-tris (pentafluoro-phenyl)-borate, preferably methyl- or ethyl-tris(pentafluoro-phenyl)-borate, tetrakis-(3,5-bis[trifluoromethyl]-phenyl)-borate, tetrakis-(3,5-bis[di(trifluoromethyl)-Z-methyl]-phenyl)-borate wherein substituent Z is fluoro-, C1-C4 alkoxy- or trifluoromethyl-C1-C3-alkoxy-. These compounds are well known in the art. Useful synthetic methods are described, along with further work referenced, e.g. Kobayashi et al., J. Fluorine Chemistry, Vol. 54, September-October 1991, p. 61 ff. [4]

### EQUIVALENTS

The representative examples that follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. It should further be appreciated that the contents of those cited references are incorporated herein by reference to help illustrate the state of the art.

The following examples contain important additional information, exemplification and guidance that can be adapted to the practice of this invention in its various embodiments and the equivalents thereof.

### EXEMPLIFICATION

The compounds of this invention and their preparation can be understood further by the examples that illustrate some of the processes by which these compounds are prepared or used. It will be appreciated, however, that these examples do not limit the invention. Variations of the invention, now known or further developed, are considered to fall within the scope of the present invention as described herein and as hereinafter claimed.

### EXPERIMENTAL SECTION

### Example 1

### Synthesis of the Cationic Complex [L₃ZnOCH₂Ph]⁺ (L=Et₂O) Via (Et₂O)₃Znme⁺ B(C₆F₅)₄⁻

In a Schlenk flask under dry N₂, [H(OEt₂)₂][B(C₆F₅)₄] (154.0 mg, 1.00 mmol) was dissolved in 10 mL of dry Et₂O and an equimolar amount of ZnMe₂ (185 μL, 1.00 mmol) was added via a syringe. The reaction mixture was stirred at room temperature for 1 h and evaporated to dryness to afford a colorless residue. The crude product was subsequently washed with pentane to quantitatively afford the zinc cation (Et₂O)₃ZnMe⁺ as a B(C₆F₅)₄⁻ salt. The latter was then dissolved in CH₂Cl₂ (5 mL) and PhCH₂OH (104 μL, 1.00 mmol) and allowed to react for 1 h at room temperature, after which it was evaporated to dryness and washed with pentane to yield (Et₂O)₃ZnOCH₂Ph⁺ as a B(C₆F₅)₄⁻ salt, as a colorless solid (95% yield, 224 mg).

¹H NMR (300 MHz, CD₂Cl₂): δ 7.45 (m, 3H, Ph), 7.31 (m, 2H, Ph), 4.96 (s, CH₂-Ph), 3.91 (6H, CH₂-Et₂O), 1.29 (9H, CH₂-Et₂O).

### Example 2

### Synthesis of the Zn-lactate cation [L₂Zn(κ²(OCHMe-C(═O)—OMe))]⁺ B(C₆F₅)₄⁻ (L=THF) from (Et₂O)₃ZnEt⁺ B(C₆F₅)₄⁻

In a vial sample under dry N₂, the zinc salt (Et₂O)₃ZnEt⁺ B(C₆F₅)₄⁻ (20 mg, 0.02 mmol) was dissolved in THF and an equimolar amount of methyl lactate (2 μL) was added. The resulting colorless solution was stirred for 1 h at room temperature, after which it was evaporated to dryness and washed with pentane to yield [L₂Zn(κ²—(OCHMe-C(═O)—OMe))]⁺ as a B(C₆F₅)₄⁻ salt (colorless solid, 95% yield, 21 mg).

¹H NMR (300 MHz, THF-d⁸): δ 4.53 (q, 1H, CH), 3.95 (s, 3H, OMe), 3.51 (m, 8H, THF), 1.93 (m, 8H, THF), 1.45 (d, 3H, CHMe).

### Example 3

### Synthesis of the Cationic Complex [L₃ZnOCH₂Ph]+ (L=THF, pyridine) via (Et₂O)₃ZnMe⁺ B(C₆F₅)₄⁻

For the synthesis of the zinc cations with L=THF or pyridine, the experimental procedure is the same as in exp. 1 above up to the formation of (Et₂O)₃ZnMe⁺ as a B(C₆F₅)₄⁻ salt. At that stage, different from exp. 1 above, the latter was then dissolved in THF (or pyridine) to afford the corresponding (L)₃ZnMe⁺ cation as a B(C₆F₅)₄⁻ salt. This was subsequently converted again as described in exp. 1 to the zinc alkoxide cation (L)₃ZnOCH₂Ph⁺ (as a B(C₆F₅)₄⁻ salt). In all cases, the salts species were isolated as colorless solids.

### Example 4

### Polymerization Experiments

4.a ROP of rac-lactide (Bulk conditions: in melted monomer matrix, @130° C.):

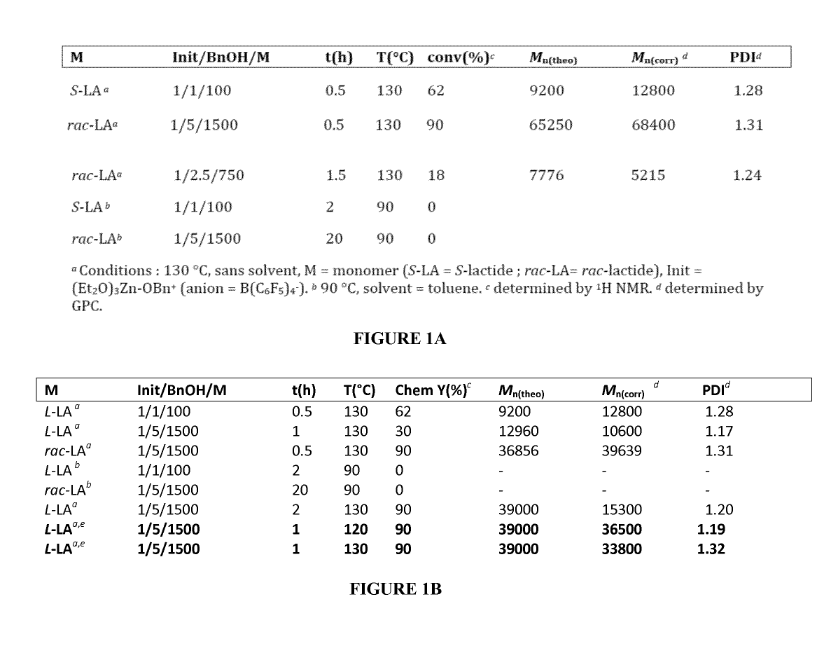

Complex [(Et₂O)₃ZnOCH₂Ph][B(C₆F₅)₄] (5 mg, 5 μmol, 1 equiv.) was charged in a flask under nitrogen, and the desired number of equiv. of BnOH (5 equiv.) was added at room temperature. The appropriate amount of rac-lactide was then added (1.08 g, 7.53 mmol, 1500 equiv.). The flask was tightly closed, placed in a pre-heated oil bath at 130° C. and vigorously stirred for 30 min. After this time, the reaction mixture was allowed to cool to room temperature and an aliquot was analyzed by ¹H NMR to estimate the monomer-to-polymer conversion (90% conversion to PLA). The reaction mixture was then quenched with MeOH provoking the precipitation of the polymer as a colorless solid. A subsequent filtration was carried out and the PLA material was dried under vacuum till constant weight. ¹H NMR analysis, MALDI-Tof and SEC analysis agree with a narrow disperse PhCH₂O-chain-ended material (GPC data: Mn=68400 g·mol-1, PDI=1.31). The reaction data are given in the table in FIG. 1, line 2 as well.

### 4.b ROP of S-Lactide (Bulk Conditions: In Melted Monomer Matrix, @130° C.):

The same procedure as in section 3.a was used for the polymerization of L-LA.cp. FIG. 1, table, line 1

### 4.c.i In Situ Catalyst Activation Procedure:

The reactive zinc alkoxide initiator species may be generated in situ in the presence of the lactide monomer using [(Et₂O)₃ZnMe][B(C₆F₅)₄] as the pre-initiator and with direct addition of benzyl alcohol (see procedure below).

Complex [(Et₂O)₃ZnMe][B(C₆F₅)₄] (5 mg, 5 μmol, 1 equiv.) was charged in a flask under nitrogen, and the desired number of equiv. of BnOH (6 equiv.) was added at room temperature. The appropriate amount of rac-lactide was then added (1.08 g, 7.53 mmol, 1500 equiv.). The flask was tightly closed, placed in a pre-heated oil bath at 130° C. and vigorously stirred for 30 min. After this time, the reaction mixture was allowed to cool to room temperature and an aliquot was analyzed by ¹H NMR to estimate the monomer-to-polymer conversion (90% conversion to PLA). The reaction mixture was then quenched with MeOH provoking the precipitation of the polymer as a colorless solid. A subsequent filtration was carried out and the PLA material was dried under vacuum till constant weight. ¹H NMR analysis, MALDI-Tof and GPC analysis agree with a narrow disperse PhCH₂O-chain-ended material (GPC data: Mn=68400 g·mol-1, PDI=1.31).

### 4.c.ii ROP of ε-Caprolactone (Bulk Conditions: In Liquid Monomer, @60° C.):

Complex [(Et₂O)₃ZnMe][B(C₆F₅)₄] (5 mg, 5 μmol, 1 equiv.) was charged in a flask under nitrogen, and the desired number of equiv. of PhCH₂OH (3 equiv.) was added at room temperature. The appropriate amount of rac-lactide was then added (860.0 mg, 7.53 mmol, 1500 equiv.). The flask was tightly closed, placed in a pre-heated oil bath at 60° C. and vigorously stirred for 2 h. After this time, the reaction mixture was allowed to cool to room temperature and an aliquot was analyzed by ¹H NMR to estimate the monomer-to-polymer conversion (91% conversion to ε-PCL). The reaction mixture was then quenched with MeOH provoking the precipitation of ε-PCL as a colorless solid. A subsequent filtration was carried out and the ε-PCL material was dried under vacuum till constant weight. ¹H NMR analysis, MALDI-Tof and SEC analysis agree with a narrow disperse PhCH₂O-chain-ended material (GPC data: Mn=52000 g·mol⁻¹, PDI=1.8).

### 4.d ROP of Trimethylene Carbonate (TMC) (Bulk Conditions: In Liquid Monomer, @ 70° C.):

The same procedure as for the ROP of ε-caprolactone in the preceding section was followed:

Complex [(Et₂O)₃ZnMe] [B(C₆F₅)₄] (5 mg, 5 μmol, 1 equiv.) was placed in a flask and 3 equiv. PhCH₂OH (1.56 μl, 15 μmol, 3 equiv.) were added, followed by the addition of TMC (255.2 mg, 2.5 mmol, 500 equiv.). The flask was tightly closed, placed in a pre-25 heated oil bath at 60° C. and vigorously stirred for 90 min. After this time, the reaction mixture was allowed to cool to room temperature and an aliquot was analyzed by ¹H NMR to estimate the monomer-to-polymer conversion (quantitative conversion to poly(trimethylene) carbonante (PTMC)). The reaction mixture was then quenched with MeOH provoking the precipitation of PTMC as a colorless solid. A subsequent filtration was carried out and the PTMC material was dried under vacuum till constant weight. ¹H NMR analysis, MALDI-Tof and SEC analysis agree with a narrow disperse PhCH₂O-chain-ended material (GPC data: Mn=56000 g·mol⁻¹, PDI=1.31)

### Example 5

### Optimisation/Improvements of ROP Catalytic Performances Via Tuning of the Reaction Conditions

The main objective of this experiment was to optimise the ROP performances of the Zn-based ROP catalyst described in the preceding examples and involved an optimisation of the reaction conditions along with testing several Zn-based catalysts for a reasonable stability/reactivity balance.

We have demonstrated that zinc compounds of type 1, readily prepared [5], were converted to the corresponding Zn alkoxide cations in situ. This catalytic species showed to efficiently mediate the controlled ROP of lactide under solvent-free and milder conditions (120° C.) than those required for the Sn-based catalyst (scheme 4). The polydispersity index (PDI) measured corresponds to a measurement of the heterogenicity of the produced polymers. It is calculated as the ratio of Mw (Weight average molar mass) by Mn (Number average molar mass). Ideally, PDI should be equal to 1, showing a homogeneous mixture of polymers with equal length. Polymers obtained with our catalysts showed satisfactory PDI indexes ranging from 1.1 to 1.4, consistent with well-defined polymers.

In contrast to the results derived from the bulk conditions, carrying out these ROPs in solution (toluene or THF, 60-100° C.) led to lower ROP activity and polymerisation control (high PDI). An attractive feature of these Zn-initiated ROPs (under bulk conditions) apparently lies on the fact that L-lactide (presumably) acts both as a supporting ligand (to stabilise the cationic Zn metal centre) and a monomer source to be converted to PLA as the ROP proceeds. This prevents from the use of complex (and potentially toxic) ligands to stabilise the catalytic species.

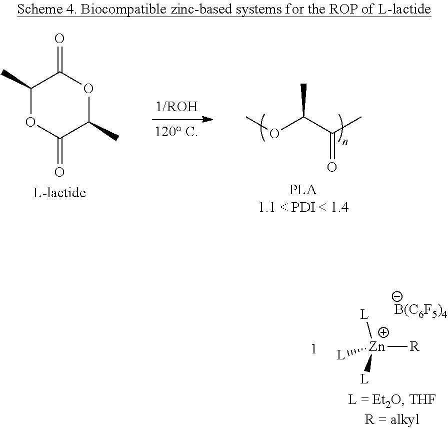

Key and representative data are compiled in FIG. 1 and substantiate the controlled nature of the ROP reaction with the production of chain-length controlled and narrow disperse PLA (with a 1.2 average PDI). Benzyl alcohol (BnOH), which is used in the reactions, terminates the polymer chain on both sides (green parts).

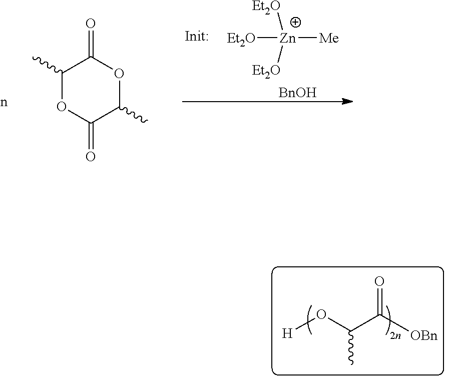

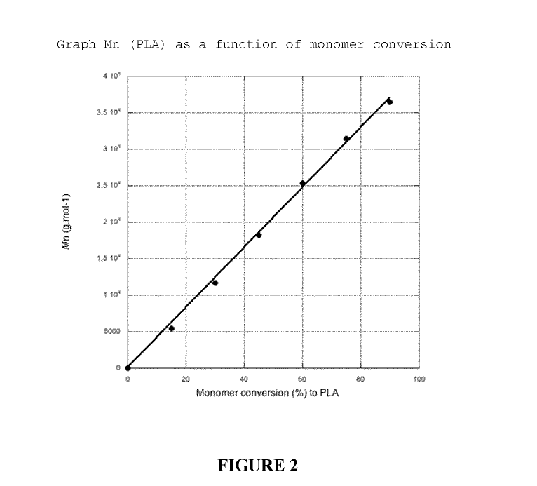

The controlled character of these polymerisations is further reflected by the linear correlation between the Mₙ (of the produced PLA) and monomer conversion (FIG. 2).

We also uncovered that the use of methyl lactate as an alcohol source allowed the synthesis of the corresponding Zn-lactate cation 2 (scheme 5), an easy-to-handle air-stable solid (unpublished results). Compound 2 features similar ROP performances to those observed with catalyst combination 1/ROH, demonstrating that this class of catalysts may combine robustness, catalytic efficiency and control.

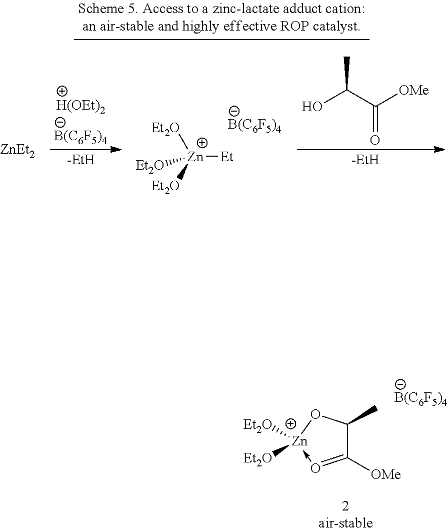

### Example 6

### Polymer Analysis

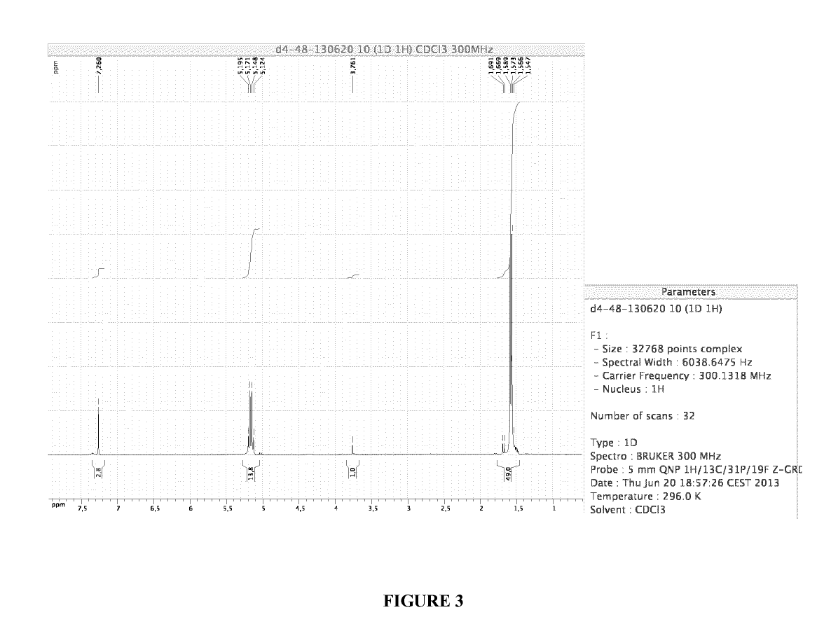

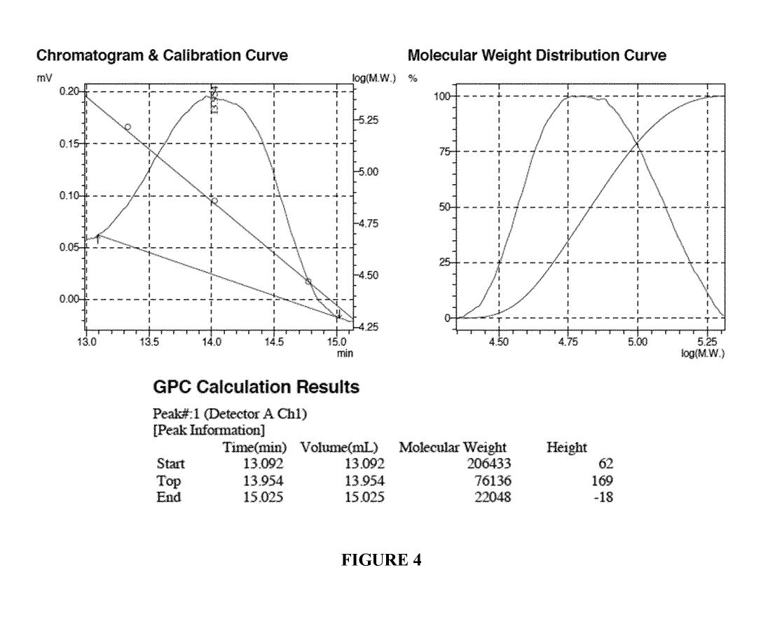

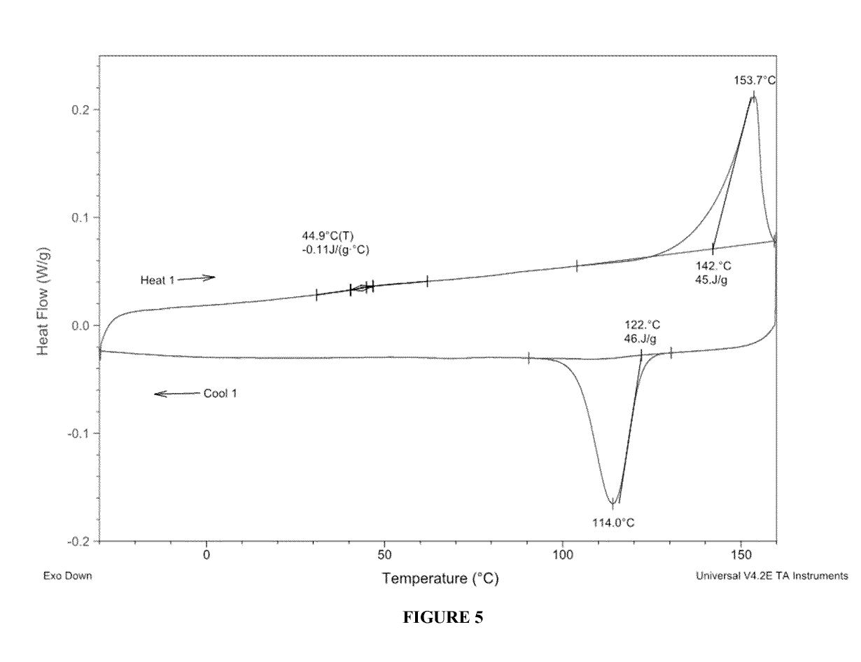

The polymers synthesized in the preceding Examples were analyzed.
The NMR data for the produced PLA confirmed the production of isotactic PLLA (from L-LA) and are consistent with the absence of epimerisation (partial change from L-LA to D-LA) as the ROP proceeds (See FIG. 3).
The Gel Permeation Chromatography (GPC) data agree with the formation of chain-length controlled and narrow disperse PLA (see Table 1 and FIG. 4 for a representative GPC chromatogram of a produced PLA sample).
The differential scanning calorimetry (DSC) used for melting point determination confirmed the semi-crystalline nature of the polymers (FIG. 5).

Overall, these studies allow the following conclusions regarding the achievements and/or potentialities of these Zn-based catalysts:
1) the combination of readily accessible Zn cations and an alcohol source allows the efficient and controlled bulk of lactide under milder bulk conditions.
2) the relevance and suitability of biocompatible zinc-based ROP catalysts versus classical tin-based catalysts has been validated.
3) In addition to be highly effective, these polymerisation reactions proceed in a controlled manner to afford chain-length controlled and narrow disperse PLA.
4) Remarkably, these simple Zn cations perform better in the ROP of lactide (whether regarding productivity and control) than previously reported cationic Zn analogues supported by more sophisticated polydentate ligands. [6] See in particular Table 3 reported in reference [6a], where the polymers' PDI are around 2, which indicate broad molecular weight distribution. The PDI reported in ref 6a are directly comparable with the PDI values reported herein, since both methods use polystyrene as standard, THF as eluting solvent, and the correcting factor 0.58.

Below are notable advantages of the method according to the present invention (there are not meant to be limiting):

1—PLA Synthesis

Two main methods are currently under use for the PLA synthesis: direct polycondensation, either in solution or in melt state, and ROP. Constant and significant efforts are to be devoted to the development of new catalysts, new polymerisation conditions and biosynthesis attempts.

Advantages and drawbacks of these methods are summarised in Table 1 below: [7]

TABLE 1

| Synthetic method | Advantages | Drawbacks |
|---|---|---|
| Solution | From lactic acid, | Side reactions (epimerisation), low |
| polycondensation | economical and | molecular weight (MW) PLA, |
| | easy to control | solvent waste (pollution) |
| Melt | | Quality of the resulting PLA hardly |
| polycondensation | | reproducible, toxic catalysts |
| ROP | Higher MW PLA | Higher monomer cost |
| Biosynthesis | Efficient and non- | Scale-up possibility yet to be |
| | toxic | demonstrated |

Polycondensation from lactic acid, either in solution or in the melt state affords mostly atactic PLA with qualities hardly compatible with new industrial applications (biomedicine, transports, etc.). Biosynthesis remains marginal as a ton-scale production from bacteria unveils reproducibility issues.

ROP suffers from higher monomer cost as the lactide has to be produced first from lactic acid. However, ROP provides high quality PLA suitable for the replacement of petrol-based polymers (PP, PET, PMMA, etc.).

In conclusion, the improved ROP according to the present invention provides PLA with better quality, reproducibility and at a large scale. Mass production with ROP easily overcomes extra costs induced by the use of the lactide.

2—Solvent-Free (or <<Melt>>) ROPs of Lactide and Catalysts

Solvent-free ROPs of lactide initiated by well-defined and ligand supported metal complexes have been previously described and typically exhibit moderate catalytic activity and/or moderate polymerisation control. Of particular relevance, Davidson, Jones and al. have developed various ligand-supported Zn— and group 4 metal complexes for the solvent-free ROP of lactide. For instance, Zn(II) compounds bearing Schiff base bidentate ligands were shown to efficiently mediate the ROP of lactide (130° C.) though with a moderate polymerisation control (PDI>1.4) and lower activity versus the proposed Zn cations. [8] Also, these authors developed remarkably robust group 4 complexes chelated by tetra- and tri-dentate phenol-type ligands, which were demonstrated to effectively mediate the melt ROP of lactide for the production of heterotactically enriched PLA with a good level of control (including stereocontrol) and activity. [9] We also developed carbene-based Zr systems found to efficiently ring-open polymerise lactide under melt conditions, yet with a lower catalytic activity than the present “chelating-ligand-free” Zn cations. [10]

Literature precedents on the use of well-defined metal organocations are rather rare and these all involved either the use of alkyl cations (of the type Zn—R⁺, in the absence of ROH source) [11] or chelating-ligand-supported Zn alkoxide species. [12] Most of these systems were found to polymerise cyclic lactones (Lactide, γ-caprolactone) in solution in a rather ill-defined manner and with a poor efficiency (poor chain length control, PDI>1.5).

In opposition to guidance and teachings in the art, the inventors selected the use of mono-dentate zinc catalysts for the melt ROP of lactide. Specifically, sterically unprotected Zn alkoxide catalysts are well-known to be unstable in solution and to readily form ill-defined aggregates.

Surprisingly and unexpectedly, a controlled and efficient melt ROP of lactide was observed when carrying out the ROP synthesis according to the present invention. Remarkably, these catalysts perform better in melt ROP of lactide than any other Zn cations reported so far (whether for solution or melt ROP) regarding catalytic performance and polymerisation control. Under melt conditions, it seems likely that single site Zn cationic centres are at play with the monomer acting like a stabilising ligand (for the Zn(II) centre) prior to its ring-opening.

The Zn-based and “ligand-free” cationic catalysts according to the present invention here have thus allowed access to narrow disperse PLA with ca. 40 kDa (Mₙ) via a controlled ROP of lactide.

However, in the view of the robustness of the catalyst under ROP conditions and the controlled character of the ROPs, it appears very likely that higher monomer/catalyst ratios will lead to higher molecular PLAs (with Mₙ>100 kDa) of commercial interest. Reproducing Example 3 with varying monomer/catalyst ratios would readily allow to verify this. As a comparison, production of PLA via polycondensation typically requires harsher reaction conditions and results into the formation of broadly disperse (PDI>1.5) PLA material. [13]

Accordingly, the polymerization method of the present invention provides a simple method to produce high quality PLA.

In addition, the Zn catalysts of type 1 were also found to mediate the bulk (solvent free) ROP of other cyclic esters/carbonates (such as ε-caprolactone, trimethylene carbonate) in a controlled fashion, which augurs well the possibility of controlled macromolecular engineering (via, for instance, block or random co-polymerisation of different monomers to access biomaterials with novel properties) using these simple Zn catalysts.

While we have described a number of embodiments of this invention, it is apparent that our basic examples may be altered to provide other embodiments that utilize the catalysts and methods of this invention. Therefore, it will be appreciated that the scope of this invention is to be defined by the appended claims rather than by the specific embodiments that have been represented by way of example.

### LIST OF REFERENCES

1. Wheaton et al., Chem. Commun. 2010, 46, 8404-8406.
2. Romain et al., Chem. Commun. 2012, 48, 22 13-2215.
3. Ovitt et al., J. Polymer Sc. 2000, Part A: Polymer Chemistry, Vol. 38, 4686-4692).
4. Kobayashi et al., J. Fluorine Chemistry, Vol. 54, September-October 1991, p. 61 ff.
5. Bochmann et al. Organometallics 2004, 23, 3296
6. (a) Sun, H.; Ritch, J. S.; Hayes, P. G. Inorg. Chem. 2011, 50, 8063. (b) Wheaton, C. A.; Hayes, P. G.; Ireland, B. J. Dalton Trans. 2009, 4832. (c) Hayes, P. G.; Wheaton, C. Canadian Patent CA 2686355.
7. L. Xiao, B. Wang, G. Yang, M. Gauthier Poly(Lactic Acid)-Based Biomaterials: Synthesis, Modification and Applications Intech 2012, 247-282.
8. Jones, Davidson et al. Eur. J. Inorg. Chem. 2009, 635.
9. Davidson et al. Chem. Commun. 2008, 1293.
10. Dagorne, Bellemin-Laponnaz et al. CNRS-Clariant WO2012076140 (A1) (2012-06-14)
11. Bochmann et al. Organometallics 2004, 23, 3296.
12. Sun, H.; Ritch, J. S.; Hayes, P. G. Inorg. Chem. 2011, 50, 8063.
13. Moon, S.-I. et al. Polymer Commun. 2001, 42, 5059.
14. Save et al., Macromol. Chem. Phys. 2002, 203, 889-899.

1. Method of polymerisation, preferably for obtaining a polymer which is a polyester or a polycarbonat or a mixed-polymer thereof, comprising the step of polymerising at least one type of monomer selected from the group consisting of a monomer of formula I 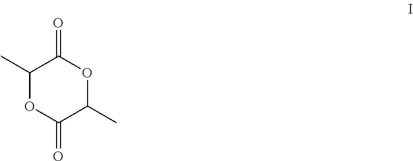
a monomer of formula II 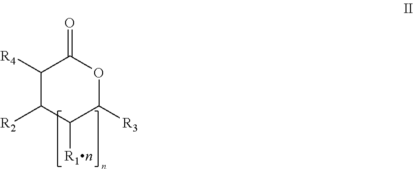
and a monomer of formula III 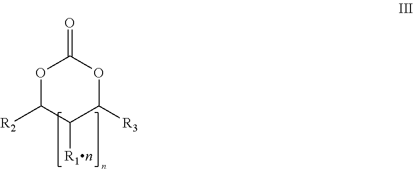
wherein for each of formulae I, II, III independently,
n=0, 1 or 2. It is particularly preferred that in formula II n is preferably 1 or 2, more preferably is 1, and/or that in formula III, n is preferably 1;
R1.n, R2, R3 and R4, independently, represent H, C1-C25 linear, branched or cyclic alkyl, C5-C25, preferably C6-C14, alkylaryl, aralkyl or aryl, wherein the alkyl and/or the aryl moieties may be, individually, further substituted with halogeno, preferably CI or F, or wherein the alkyl may comprise an oxirane, ether, amido, amidino, alkenyl or alkinyl moiety;
in the presence of a cationic initiator complex of formula IV
(Lₘ M-R^{a})⁺ IV
or of formula V
(Lₘ M-O—R^{a})⁺ V
wherein
L represents a neutral, monodentate ligand;
m=1, 2, 3 or 4;
M represents a zinc, magnesium or calcium atom, preferably a zinc atom, having an oxidation state of +11;
R^{a} represents an organic radical which is linear, branched or cyclic, preferably linear, C1-20alkyl, preferably C1-C10alkyl, or Si1-Si10silyl, C6-C14 alkylaryl, aralkyl or aryl, and wherein the alkyl or aryl moieties may be, individually, further substituted with halogeno, preferably F or CI, and wherein the aryl moieties may comprise N- and/or O-heteroaromatic aryl (i.e. an N- or O-containing heteroaryl moiety), and wherein the alkyl, silyl or aryl moieties may be, individually, further substituted with —NR^{b}R^{c}, —COO—R^{b}, -0-C(=0)-R^{b}, —NH—C(=0)-R^{b}, —C(=0)NH—R^{b}, —OH, —NHC(=0)NHR^{b}, —OBoc, —NHBoc, (-(0)ᵥSi[-(0)ₓR^{b}][-(0)_{y}R^{c}][-(0)_{z}R^{d}])i with the proviso that v, x, y, z are, individually, 0 or 1, and that 1 is 1, 2, 3, 4 or 5; or wherein, when the complex is of formula V, the alkyl, silyl c, or aryl moieties may be, individually, further substituted with —O—R^{b}, —S—R^{b} or —PR^{b}R^{c},
wherein R^{b}, R^{c}, R^{d}, individually, are CI-CI 4 alkyl or C6-C14 aryl, arylalykl or aralkyl, which alkyl or aryl moieties may be further substituted with halogeno, preferably CI or F;
and wherein, when the polymerisation reaction is carried out with a cationic initiator complex of formula IV, then either the reaction is carried out in the further presence of an alcohol of formula VI
R^{a}—OH, VI
or that the initiator complex is preincubated with an alcohol of formula VI, or both.

2. Method of polymerisation according to claim 1, wherein the polymerisation is carried out comprising at least monomer of formula I, and wherein the monomer of formula I is S-lactide (S,S-lactide) and/or is rac-lactide.

3. Method of polymerisation according to claim 1, wherein the polymerisation is carried out in the presence of alcohol of formula VI and substantially in the absence of any solvent other than the alcohol of formula VI and liquid monomer, preferably at a temperature of from 110 to 145° C. and at a molar ratio of the initiator complex IV and/or V: alcohol VI: monomer of formula I, II and/or III of from 1:<3:<1000; most preferably said molar ratio ranges from 1:<4 to <10:<1500.

4. Method of polymerisation according to claim 1, wherein the initator complex has the following structure: 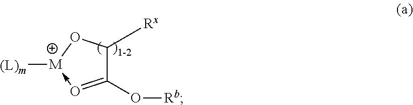
wherein, m, L and Rⁿ are as defined in claim 1, and each occurrence R^{X}
independently represents H or C1-6alkyl.

5. Method of polymerisation according to claim 1, wherein the polymerisation mixture consists essentially of the alcohol of formula VI, the initator complex and at least one of the monomers I, II and/or III.

6. Method of polymerisation of claim 2, wherein the polymerisation is carried out to provide a block-copolymer product of the monomers of formula I and formula III.

7. Method of polymerisation according to claim 1, wherein the polymerisation provides a polymer product having a number-average molecular weight (Mn)>50.000 g/mol and a polydispersity index (PDI) value from >1 to 1.6, preferably a PDI value of from 1.05 to 1.55, more preferably a PDI value of from 1.1 to 1.4, most preferably from 1.05-1.35, measured by gas permeation chromatography with a polystyrene standard.

8. Method of polymerisation according to claim 1, wherein L is a preferably aprotic, solvent that is liquid at 25° C. and comprises N, O and/or S as heteroatom, preferably is an aromatic N, S and/or O heterocycle with a ring size of 5 or 6 atoms, or is R^{q}—NH₂, R^{p}—0-R^{o}, R^{p}—S—R^{o} or R^{p}—CN, wherein R^{q} is C6 to C14 aryl or aralkyl and wherein R^{p}, R^{o} independently, are C1-C4 aliphatic, preferably linear, alkyl or are C6-C14 aryl or alkylaryl, preferably C6-C14 alkylaryl, more preferably L is selected from the group consisting of pyridine, pyrimidine, pyridazine, piperazine, aniline, 4-methyl- and 4-ethyl-aniline, tetrahydrofurane, thiophene, oxazol, isooxazol, thiazol, isothiazol and ethers of formulae R^{p}—0-R^{o} and/or R^{p}—S—R^{o} wherein R^{p}, R^{o}, independently or symmetrically, represent C1-C3, preferably linear, alkyl, for example diethyl ether.

9. Method of polymerisation according to claim 1, wherein R^{a} may be linear, cyclic or branched CI-CIO alkyl or may be C6-C14 alkylaryl when the initiator complex is of formula V; and wherein the alkyl or aryl moieties may be, individually, further substituted with halogeno, preferably F or CI.

10. Polymer obtained by the method of claim 1, which polymer product has a number—average molecular weight (Mn)>50.000 g/mol and a polydispersity index (PDI) value from >1 to 1.6, preferably a PDI value of from 1.05 to 1.55, more preferably a PDI value of from 1.1 to 1.4, most preferably ranging from 1.05-1.35, measured by gas permeation chromatography with a polystyrene standard.

11. Polymer of claim 10, which polymer has been polymerised at least in part from the lactide monomer of formula I, optionally together with the monomer of formula III polymer to form a block-copolymer product of monomers of formula I and formula III.

12. Cationic initiator complex for ring-opening polymerisation, of formula IV
(Lₘ M-R^{a})⁺ IV
or of formula V
(Lₘ M-O—R^{a})⁺ V
wherein
L represents a neutral, monodentate ligand;
m=1, 2, 3 or 4;
M represents a magnesium, calcium or zinc atom, preferably a zinc atom, having an oxidation state of +II;
R^{a} represents an organic radical which is linear, branched or cyclic, preferably linear, Cl-20, preferably C1-C10, alkyl or Si1-Si10 silyl, C6-C14 alkylaryl, aralkyl or aryl, and wherein the alkyl or aryl moieties may be, individually, further substituted with halogeno, preferably F or CI, and wherein the aryl moieties may comprise N- and/or O-heteroaromatic aryl, and wherein the alkyl, silyl or aryl moieties may be, individually, further substituted with —NR^{b}R^{c}, —COO—R^{b}, —O—C(=0)-R^{b}, —NH—C(=0)-R^{b}, —C(=0)NH—R^{b}, —OH, —NHC(=0)NHR^{b}, -(0)Boc, —NHBoc, (-(0)ᵥSi[-(0)ₓR^{b}][-(0)_{y}R1][-(0)_{z}R^{d}])i with the proviso that v, x, y, z are, individually, 0 or 1, and that 1 is 1, 2, 3, 4 or 5, or wherein,
when the complex is of formula V, the alkyl, silyl or aryl moieties may be, individually, further substituted with —O—R^{b}, —S—R^{b} or —PR^{b}R^{c},
and wherein R^{b}, R^{c}, R^{d}, individually, are CI-CI 4 alkyl or C6-C14 aryl, arylalykl or aralkyl, which alkyl or aryl moieties may be further substituted with halogeno, preferably CI or F.

13. Cationic initiator complex of claim 12, wherein the complex is provided in the form of an ion pair or salt of formula VII
(L_{M} M-R^{A})⁺ X VII
or of formula VIII
(L_{M} M-O—RT X VIII
wherein X″ is a lipophilic, sterically hindered complex anion, preferably is an anionic borate complex.

14. Cationic initiator complex of claim 13, wherein X″ is an anionic borate complex selected from the group consisting of tetrakis(pentafluoro-phenyl)-borate,
C1-C4-alkyl-tris(pentafluoro-phenyl)-borate, preferably methyl- or ethyl-tris(pentafluoro-phenyl)-borate, tetrakis-(3,5-bis[trifluoromethyl]-phenyl)-borate, tetrakis-(3,5-bis[di(trifluoromethyl)-Z-methyl]-phenyl)-borate wherein substituent Z is fluoro-, C1-C4 alkoxy- or trifluoromethyl-C1-C3-alkoxy-.

15. Cationic initiator complex of claim 12 configured for controlled Ring-Opening Polymerisation (ROP) of cyclic lactones and carbonates.
